(19) United States
(12) Patent Application Publication
(10) Pub. No.: US 2019/0249266 A1
(43) Pub. Date: Aug. 15, 2019

(54) RIBBING PROCESS, PARTICULARLY FOR PROVIDING LEATHER COVERINGS

(71) Applicant: POLTRONA FRAU S.P.A., Meda (IT)

(72) Inventor: Gianbattista TURETTI, Tolentino (IT)

(21) Appl. No.: 16/345,480

(22) PCT Filed: Oct. 18, 2017
(86) PCT No.: PCT/EP2017/076630

§ 371 Date: Apr. 26, 2019

(30) Foreign Application Priority Data
Oct. 26, 2016 (IT) 102016000107855

(51) Int. Cl. C14B 1/56; D06C 23/04

(52) U.S. Cl. CPC C14B 1/56; D06C 23/04

(57) ABSTRACT

A ribbing process, particularly for providing leather coverings, includes the steps of
applying a covering material on a template that includes longitudinally extended seats,
inserting longitudinally extended forming rods in the seats of the template, and making the covering material adhere to the template and providing seats in the covering material. The ribbing process also includes
hot pressing a first assembly that includes the template, the covering material, and the forming rods, thermoforming the covering material, and
removing the forming rods from the first assembly.

### TECHNICAL FIELD

The present disclosure relates to a ribbing process particularly but not exclusively useful and practical in the production of leather coverings, usable for example in the field of furniture to manufacture armchairs, sofas, and so forth.

### BACKGROUND

In the jargon of the industries that operate in the textile and furniture sector, ribbing indicates the forming of a kind of more or less raised rib, which is obtained on a material, such as for example leather or fabric, as an effect of appropriate processes.

The ribbing of leather or fabric coverings is currently performed by means of stitches of various kinds applied to the material being processed. These stitches separate one rib from the adjacent ones and allow to obtain the typical visual effect and aesthetic appearance of ribbing.

However, ribbing methods of the known type are not free from drawbacks, which include the fact that said stitches between one rib of the covering and the adjacent ones are visible and are consequently unsightly, in particular from the point of view of the end consumer.

Another disadvantage of ribbing methods of the known type resides in that they allow to provide exclusively coverings provided with ribs that have a cross-section with a substantially rounded shape.

### SUMMARY

The aim of the present disclosure is to overcome the limitations of the background art described above, providing a ribbing process, particularly for providing leather coverings, that allows to form raised ribs which have variable dimensions depending on the aesthetic appearance that one wishes to obtain.

Within this aim, an the present disclosure conceives a ribbing process, particularly for providing leather coverings, that allows to avoid unsightly stitches between one rib and the adjacent ones.

The present disclosure also provides a ribbing process, particularly for providing leather coverings, that allows to form ribs that have a cross-section of variable size and with a shape that is not necessarily rounded, such as for example a substantially square cross-section, depending on the aesthetic appearance that one wishes to obtain.

The present disclosure also provides a ribbing process, particularly for providing leather coverings, that allows to pad the coverings with a padding that has a variable density depending on the degree of softness that one wishes to obtain.

The present disclosure further provides a ribbing process, particularly for providing leather coverings, that is highly reliable, relatively simple to provide, and at competitive costs if compared with the background art.

This aim, as well as these and other advantages which will become better apparent hereinafter, are achieved by providing a ribbing process, particularly for providing leather coverings, including the following steps:
applying a covering material on a template that comprises a plurality of longitudinally extended seats;
inserting a plurality of longitudinally extended forming rods in said plurality of seats of said template, making said covering material adhere to said template and providing a plurality of seats in said covering material;
hot pressing a first assembly that comprises said template, said covering material, and said plurality of forming rods, thermoforming said covering material;
removing from said first assembly said plurality of forming rods; and
cooling said template and said covering material.

The intended aim and advantages are also achieved by providing a covering that can be obtained by means of the ribbing process, particularly for providing leather coverings, described herein.

The intended aim and advantages are further achieved by providing a manufacture which comprises a covering that can be obtained by means of the ribbing process, particularly for providing leather coverings, described herein.

### BRIEF DESCRIPTION OF THE DRAWINGS

Further characteristics and advantages of the disclosure will become better apparent from the description of a preferred but not exclusive embodiment of the ribbing process, particularly for providing leather coverings, according to the disclosure, illustrated by way of nonlimiting example with the aid of the accompanying drawings, wherein:

FIG. 1 is a flowchart showing an embodiment of the ribbing process, particularly for providing leather coverings, according to the present disclosure;

FIG. 2 is an exploded perspective view of a first step of an embodiment of the ribbing process, particularly for providing leather coverings, according to the present disclosure;

FIG. 3 is a perspective view of a second step of an embodiment of the ribbing process, particularly for providing leather coverings, according to the present disclosure;

FIG. 4 is an exploded perspective view of a third step of an embodiment of the ribbing process, particularly for providing leather coverings, according to the present disclosure;

FIG. 5 is a perspective view of a portion of an embodiment of a covering obtained by means of the ribbing process, particularly for providing leather coverings, according to the present disclosure; and

FIG. 6 is a perspective view of an embodiment of an article, specifically a furniture article, which comprises a covering obtained by means of the ribbing process, particularly for providing leather coverings, according to the present disclosure.

### DETAILED DESCRIPTION OF THE DRAWINGS

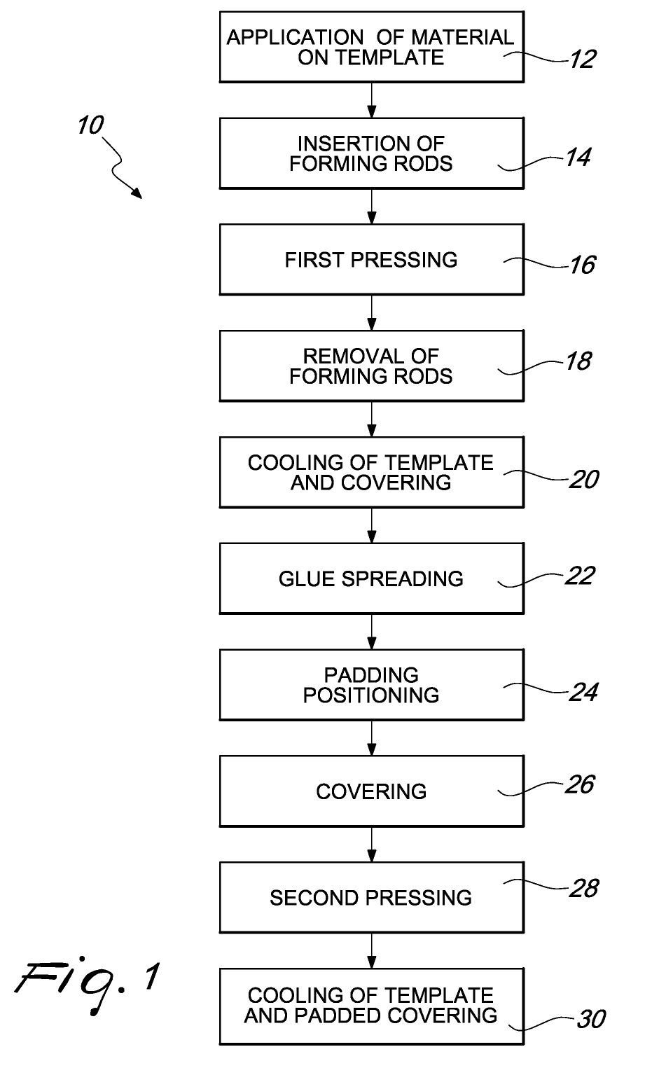

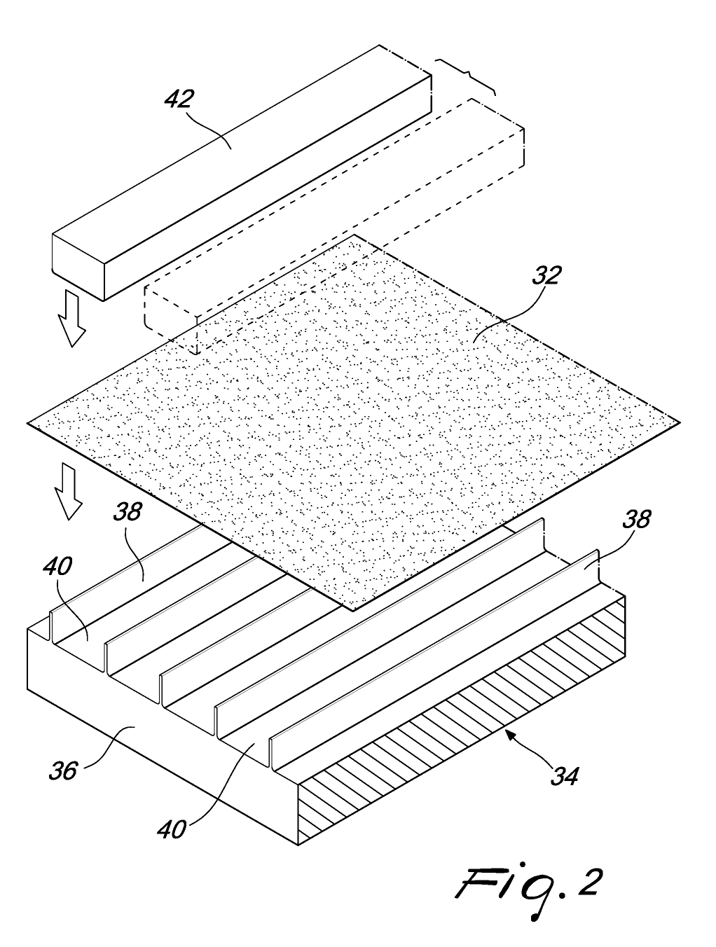

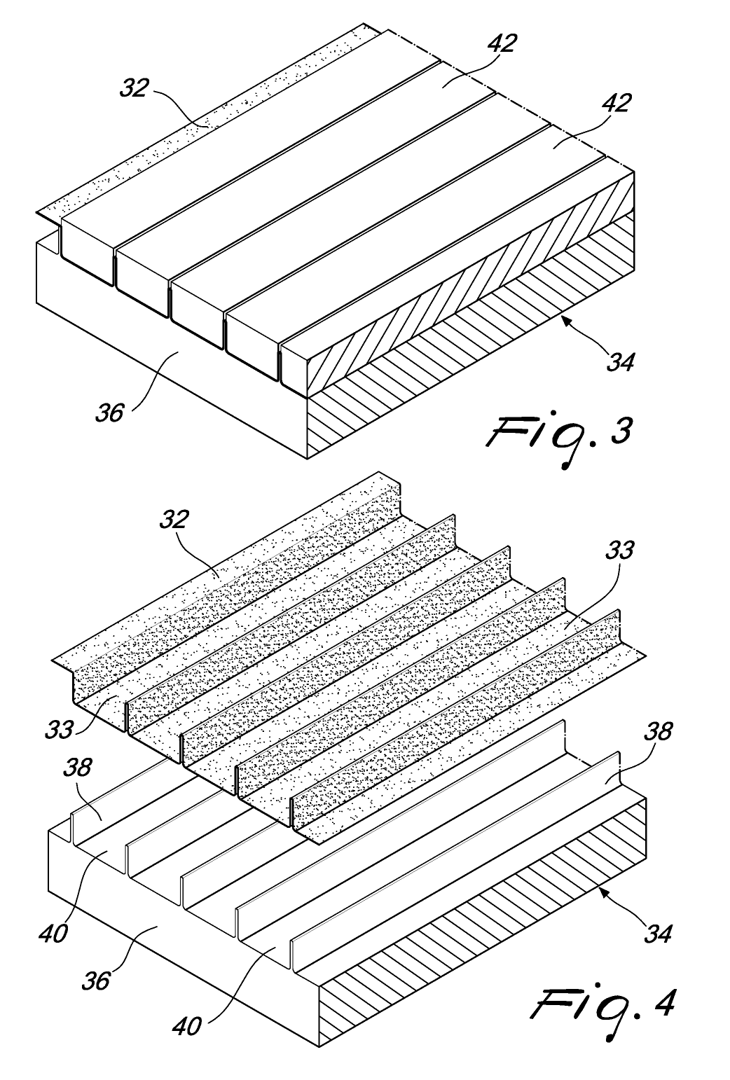

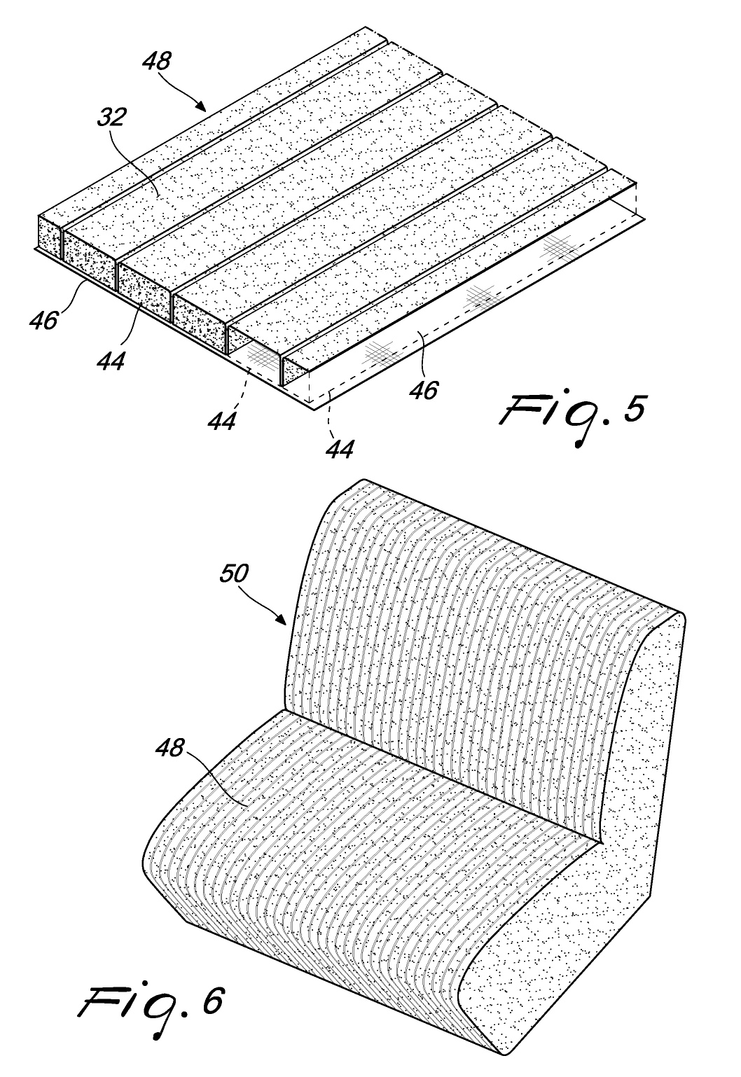

With reference to FIGS. 1-6, the ribbing process, particularly for providing leather coverings, according to the disclosure, designated generally by the reference numeral 10, comprises substantially the following steps.

Initially, in step 12 a covering material 32 being processed, such as for example a portion of leather or fabric, is spread on a template 34.

The template 34 comprises a plate-like base 36, which has an extension that can vary case by case, and a plurality of longitudinally extended and preferably mutually parallel crests 38, the height and mutual distance of which can vary case by case.

Preferably, the template 34 is made of metal. Even more preferably, the template 34 is made of aluminum or alloys thereof.

The template 34 comprises a plurality of longitudinally extended and preferably mutually parallel seats 40, which are formed and delimited by the plate-like base 36 and by the plurality of longitudinally extended and preferably mutually parallel crests 38.

The height of each seat 40 corresponds substantially to the height of the corresponding crests 38, while the width of each seat 40 corresponds substantially to the mutual distance of the corresponding crests 38.

In one embodiment of the ribbing process 10 according to the disclosure, the mutual distance between two crests 38, and therefore the width of the corresponding seat 40, is always the same along the extension of the template 34. For example, all the crests 38 can be spaced by 2 centimeters from each other, and therefore all the seats 40 can be 2 centimeters wide.

In another embodiment of the ribbing process 10 according to the disclosure, the mutual distance between two crests 38, and therefore the width of the corresponding seat 40, varies along the extension of the template 34. For example, one pair of crests 38 can be mutually spaced by 2 centimeters, and therefore the corresponding seat 40 can be 2 centimeters wide, while an adjacent pair of crests 38 can be mutually spaced by 3 centimeters, and therefore the corresponding seat 40 can be 3 centimeters wide.

Then, in step 14 a plurality of longitudinally extended forming rods 42 is inserted in the plurality of seats 40 of the template 34, so as to make the previously applied covering material 32 adhere to the template 34 and obtain a plurality of seats 33 in the covering material 32, consequently giving said covering material 32 the desired shape. In particular, at least one forming rod 42 is inserted in each respective seat 40 of the template 34.

The height of each forming rod 42 substantially corresponds to the height of the respective seat 40 increased by a few millimeters, for example 4 millimeters, in order to prevent the crests 38 from being able to bend or be damaged during pressing, while the width of each forming rod 42 corresponds substantially to the width of the respective seat 40 reduced by two thicknesses of the covering material 32.

Preferably, the forming rods 42 are made of metal. Even more preferably, the forming rods 42 are made of aluminum or alloys thereof.

Then, in step 16, the assembly comprising the template 34, the covering material 32 being processed, and the forming rods 42 is hot pressed. This first pressing 16 is adapted to thermoform the covering material 32 and render substantially irreversible the seats 33 provided in the covering material 32. For example, the hot pressing can be performed by means of a plate press of the known type.

In one embodiment of the ribbing process 10 according to the disclosure, particularly if the covering material 32 being processed is leather, this first pressing 16 occurs at a temperature comprised between 65° C. and 75° C., preferably equal to 70° C., at a pressure comprised between 2.5 and 3 kilograms per square centimeter, and for a time comprised between 75 minutes and 85 minutes, preferably equal to 80 minutes.

If the covering material 32 being processed is of another type, such as for example synthetic leather or fabric, the first pressing 16 can occur at a temperature, at a pressure and for a time that are identical or similar to the ones indicated in the paragraph cited above with reference to leather processing.

At the end of the first pressing 16, in step 18 the assembly comprising the template 34, the covering material 32 being processed, and the forming rods 42, is extracted from the press and the plurality of forming rods 42 is removed from said assembly.

Then, in step 20, the template 34 and the covering material 32 being processed are cooled. In one embodiment of the ribbing method 10 according to the disclosure, the cooling 20 occurs in rooms at ambient temperature, and therefore in a natural manner. In another embodiment of the ribbing method 10 according to the disclosure, the cooling 20 occurs in climate-controlled rooms and therefore artificially.

Once the template 34 and the covering material 32 being processed have cooled, in step 22 a layer of hot or thermoadhesive glue is spread both on the surface of the covering material 32 being processed that is directed outward, i.e., the opposite surface with respect to the surface in contact with the template 34, and on a plurality of padding strips 44, for example made of sponge rubber. Preferably, the spread hot glue is of the type with an aqueous dispersion of a polyurethane-based polymer. For example, the spreading of the hot glue can be performed by means of a spray gun or of a roller machine of a known type.

Then, in step 24, the plurality of padding strips 44 is arranged inside the plurality of seats 33 provided in the covering material 32 being processed. In particular, at least one padding strip 44 is inserted in each respective seat 33 of the covering material 32.

Then, in step 26, the assembly comprising the template 34, the covering material 32 being processed, and the padding strips 44 is covered with a covering sheet 46 made of fabric comprising a layer of hot glue that is spread on its contact surface. In particular, the covering sheet 46 makes contact mainly with the padding strips 44 and optionally with the covering material 32 being processed.

The covering sheet 46 is adapted to stabilize the resulting covering 48 and prevent unsightly effects caused for example by the movement of a padding strip 44 in the respective seat 33 of the covering material 32 being processed. Preferably, the covering sheet 46 is made of cotton. The covering sheet 46 can also be made for example of acrylic fibers or elastic fabric.

Then, in step 28, the assembly comprising the template 34, the covering material 32 being processed, the padding strips 44, and the covering sheet 46 is hot pressed. This second pressing 28 is adapted to reactivate with heat the layers of hot glue previously sprayed on the elements of the above-cited assembly, except for the template 34. For example, the hot pressing can be performed by means of a plate press of the known type.

In one embodiment of the ribbing process 10 according to the disclosure, particularly in the case in which the covering material 32 being processed is leather, this second pressing occurs at a temperature comprised between 65° C. and 75° C., preferably equal to 70° C., at a pressure comprises between 2.5 and 3 kilograms per square centimeter, and for a time comprised between 15 minutes and 25 minutes, preferably equal to 20 minutes.

If the covering material 32 being processed is of another type, such as for example synthetic leather or fabric, the second pressing can occur at a temperature, at a pressure and for a time that are equal or similar to those indicated in the paragraph cited above with reference to leather processing.

Finally, at the end of the second pressing 28, in step 30 the assembly comprising the template 34, the covering material 32 being processed, the padding strips 44, and the covering sheet 46 is extracted from the press; the covering material 32, the padding strips 44, and the covering sheet 46 being mutually glued so as to form a covering 48.

Again in step 30, the template 34 and the resulting covering 48 are cooled and, once cooled, can be picked up and used to produce a manufacture 50, such as for example the item of furniture shown in FIG. 6.

In one embodiment of the ribbing process 10 according to the disclosure, the cooling 30 occurs in rooms at ambient temperature and therefore in a natural manner. In another embodiment of the ribbing method 10 according to the disclosure, cooling 30 occurs in climate-controlled rooms and therefore artificially.

In practice it has been found that the disclosure fully achieves the intended aim and objects. In particular, it has been shown that the ribbing process, particularly for providing leather coverings, thus conceived allows to overcome the quality limitations of the background art, since it allows to provide coverings made of leather or other material provided with raised ribs with variable dimensions depending on the aesthetic appearance that one wishes to obtain.

One advantage of the ribbing process, particularly for providing leather coverings, according to the present disclosure resides in that it allows to provide coverings made of leather or other material without the unsightly stitches between one rib and the adjacent ones.

Another advantage of the ribbing process, particularly for providing leather coverings, according to the present disclosure resides in that it allows to provide coverings made of leather or other material provided with ribs having a cross-section of variable size and with a shape that is not necessarily rounded, such as for example a cross-section with a substantially squared shape, depending on the aesthetic appearance that one wishes to obtain.

A still further advantage of the ribbing process, particularly for providing leather coverings, according to the present disclosure resides in that it allows to provide coverings made of leather or other material which are padded, with the use of a padding that has a variable density depending on the degree of softness that one wishes to obtain.

Although the ribbing process according to the disclosure has been conceived in particular to provide coverings made of leather, it can in any case be used more generally to provide coverings made of any material suitable for this use, such as for example synthetic leather, fabrics, cloths, velvets and/or nonwoven fabrics.

The disclosure thus conceived is susceptible of numerous modifications and variations, all of which are within the scope of the appended claims. All the details may furthermore be replaced with other technically equivalent elements.

In practice, the materials used, so long as they are compatible with the specific use, as well as the contingent shapes and dimensions, may be any according to the requirements and the state of the art.

To conclude, the scope of the protection of the claims must not be limited by the illustrations or preferred embodiments shown in the description by way of example, but rather the claims must comprise all the characteristics of patentable novelty that reside in the present disclosure, including all the characteristics that would be treated as equivalents by the person skilled in the art.

The disclosures in Italian Patent Application No. 102016000107855 (UA2016A007687) from which this application claims priority are incorporated herein by reference.

1-10. (canceled)

11. A ribbing process, comprising the steps of:
applying a covering material on a template that comprises a plurality of longitudinally extended seats;
inserting a plurality of longitudinally extended forming rods in said plurality of seats of said template, making said covering material adhere to said template and providing a plurality of seats in said covering material;
hot pressing a first assembly that comprises said template, said covering material, and said plurality of forming rods, thermoforming said covering material;
removing from said first assembly said plurality of forming rods; and
cooling said template and said covering material.

12. The ribbing process, according to claim 11, further including the following steps:
spreading a layer of hot glue both on the surface of said covering material that is directed outward and on a plurality of padding strips;
positioning said plurality of padding strips within said plurality of seats of said covering material;
covering a second assembly that comprises said template, said covering material, and said plurality of padding strips with a covering sheet which comprises a layer of hot glue that is applied to the contact surface;
hot pressing a third assembly that comprises said template, said covering material, said plurality of padding strips, and said covering sheet, reactivating with heat said layers of hot glue; and
cooling said template and a covering.

13. The ribbing process, according to claim 11, wherein said template comprises a plate-like base and a plurality of longitudinally extended crests, which are adapted to define and delimit said plurality of longitudinally extended seats.

14. The ribbing process, according to claim 11, wherein said hot pressing of the first assembly occurs at a temperature between 65° C. and 75° C., at a pressure between 2.5 and 3 kilograms per square centimeter, and for a time between 75 minutes and 85 minutes.

15. The ribbing process, according to claim 11, wherein said hot pressing of the third assembly occurs at a temperature between 65° C. and 75° C., at a pressure between 2.5 and 3 kilograms per square centimeter, and for a time between 15 minutes and 25 minutes.

16. The ribbing process, according to claim 11, wherein said template is made of aluminum or alloys thereof.

17. The ribbing process, according to claim 11, wherein said plurality of forming rods is made of aluminum or alloys thereof.

18. The ribbing process, according to claim 12, wherein said hot glue is of the type with an aqueous dispersion of a polyurethane-based polymer.

19. A covering obtainable by means of a ribbing process, according to claim 11.

20. A manufacture comprising a covering, according to claim 19.
